(19) United States
(12) Patent Application Publication
(10) Pub. No.: US 2017/0285293 A1
(43) Pub. Date: Oct. 5, 2017

(54) OPTICAL ASSEMBLY

(71) Applicant: JENOPTIK Optical Systems GmbH, Jena (DE)

(72) Inventor: Stefan MUELLER-PFEIFFER, Jena (DE)

(73) Assignee: JENOPTIK Optical Systems GmbH, Jena (DE)

(21) Appl. No.: 15/473,734

(22) Filed: Mar. 30, 2017

(30) Foreign Application Priority Data
Mar. 30, 2016 (DE) 10 2016 205 223.3

(51) Int. Cl. G02B 7/02

(52) U.S. Cl. CPC G02B 7/02

(57) ABSTRACT

An optical assembly having an optical element with an optical axis, a frame holding the optical element at a plurality of positions, and a plurality of slots, which are respectively arranged between the plurality of positions and the optical axis in the optical element.

This nonprovisional application claims priority under 35 U.S.C. §119(a) to German Patent Application No. 10 2016 205 223.3, which was filed in Germany on Mar. 30, 2016, and which is herein incorporated by reference.

### BACKGROUND OF THE INVENTION

### Field of the Invention

The present invention relates to an optical assembly comprising a frame and an optical element held in this frame.

### Description of the Background Art

Frames for optical elements are constructed depending on the requirements on the imaging quality and the given transportation, storage and use conditions of the optical system, a component of which is formed by the held optical element. Here, expected shock loads, possible temperature variations during transport, storage and use, and the energetic and spectral influence of radiation during use, in particular, play a role. Independently of the aforementioned loads, the optical element must be held in a defined position within the frame with little stress.

Moreover, a problem which may arise in mechanical frames, in particular, is that the optical element is deformed by the forces occurring here. Such a deformation may impair the optical power of the optical element. As a consequence, such a reduction in power may have an effect on the whole system in which the optical element is installed. A reduction in power may have a negative effect on a possible processing process, in particular in the case of high power lenses which, for example, are used in laser-material processing.

In a schematic view, FIG. 1a and FIG. 1b show such an optical assembly 1 in accordance with the prior art in a side view (FIG. 1a) and in a top view (FIG. 1b). The optical assembly 1 has an optical element 2 with an optical axis A and a frame, which is embodied to hold the optical element 2 at a plurality of positions 4. The optical element 2 is embodied as a lens. The lens guide rays, which are incident on a first surface 2a, onto an image plane which is disposed downstream of a second surface 2b in the beam direction. The frame is a mechanical frame which holds the optical element 2 at three positions 4 by means of the action of force 6. The three positions 4 are bearing elements 3, which are formed in monolithic fashion at the optical element 2.

As a result of the action of force 6, a stress field 5 is induced in the optical element 2 and, in the process, in the region which is used optically in particular, the stress field possibly leads to a deformation of the optical element as a consequence.

### SUMMARY OF THE INVENTION

It is therefore an object of the present invention to provide an optical assembly which reduces or entirely prevents an influx of stress such that no substantial deformation of the optical element may occur.

In an exemplary embodiment of the invention, an optical assembly comprises: an optical element with an optical axis; a frame embodied to hold the optical element at a plurality of positions; and a plurality of slots, which are respectively arranged between the plurality of positions and the optical axis in the optical element.

What arranging a plurality of slots in the optical element achieves is that the stress field produced by the action of force is deflected away from the optically usable region of the optical element. According to the invention, the technical feature “slot” may be understood to mean a groove or a separation cut from a first surface to a second surface of the optical element.

In an exemplary embodiment, the optical element can comprise a first surface and a second surface and for the plurality of slots in each case to be embodied continuously from the first surface to the second surface.

In accordance with an embodiment, the optical element may comprise a plurality of bearing elements and the plurality of positions may be formed by the plurality of bearing elements.

In accordance with an embodiment, the optical element may have a rotationally symmetric embodiment and the plurality of slots may be embodied as circular segments in the optical element.

In accordance with an embodiment, the plurality of slots may each have a first end and a second end and the plurality of positions may be arranged between the first end and the second end in each case, for example, midway between the first and the second end in each case. Arranging the plurality of positions midway between the two ends of the slot in each case obtains a particularly expedient dissipation of the stress field.

In accordance with an embodiment, the optical element may comprise exactly three bearing elements, which are respectively arranged offset from one another by 120°. However, it is also conceivable for the optical element to comprise four, five, six or a plurality of bearing elements.

In accordance with an embodiment, the bearing elements may be embodied in monolithic fashion on the optical element or the bearing elements may be cemented to the optical element in accordance with an alternative embodiment.

Further scope of applicability of the present invention will become apparent from the detailed description given hereinafter. However, it should be under-stood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1a shows a schematic structure of an optical assembly in accordance with the prior art in a side view;

Fig. 1b shows a schematic structure of an optical assembly in accordance with the prior art in a top view;

FIG. 2a shows a schematic structure of an exemplary embodiment of an optical assembly according to the invention in a side view; and

FIG. 2b shows a schematic structure of an exemplary embodiment of an optical assembly according to the invention in a top view.

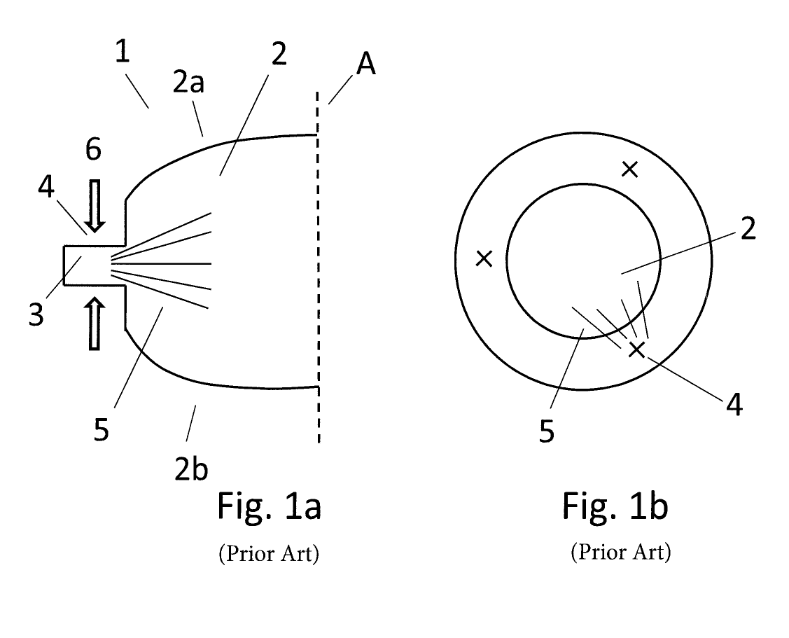

### DETAILED DESCRIPTION

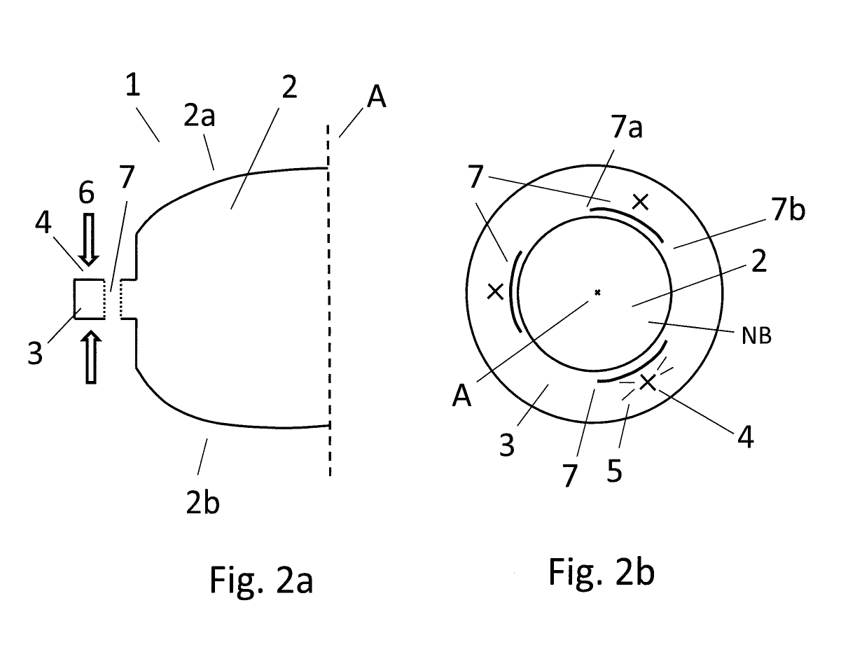

In a schematic view, FIG. 2a and FIG. 2b show an exemplary embodiment of an optical assembly 1 according to the invention in a side view (FIG. 2a) and in a top view (FIG. 2b).

The optical assembly 1 comprises an optical element 2 with an optical axis A and a frame, which is embodied to hold the optical element 2 at a plurality of positions 4. The optical element 2 is embodied as a lens in an exemplary manner, preferably as high-power lens. The lens is embodied to guide rays, which are incident on a first surface 2a, onto an image plane which is disposed downstream of a second surface 2b in the beam direction. All imaging optical elements such as lenses and mirrors may be used as optical elements, without this, however, restricting the possibility of using the frame in conjunction with filters or optical discs.

The frame is embodied as a mechanical frame which holds the optical element 2 at three positions 4 by means of the action of force 6. The three positions 4 are embodied as bearing elements 3. The bearing elements may be cemented onto the optical element 2 or, like in this exemplary embodiment, be formed in monolithic fashion at the optical element.

The optical element 2 has a rotationally symmetric embodiment and comprises exactly three positions 4, which are arranged offset from one another by approximately 120°. Here, the three positions 4 are arranged outside of an optically usable region NB of the optical element 2.

In accordance with the shown exemplary embodiment, the optical element 2 now comprises three slots 7 which are respectively arranged between the optical axis A and the three positions 4. Or, expressed differently: the three positions 4 have a greater distance from the optical axis A than the three slots 7. As may be gathered from the side view in accordance with FIG. 2a, all slots 7 are embodied as separation cuts and therefore reach from a first surface 2a to a second surface 2b of the optical element 2. If a comparison is now made between the two exemplary embodiments, i.e. the exemplary embodiment in accordance with the prior art and the exemplary embodiment according to the invention, it may clearly be identified that the slots 7 guide the stress field 5 away from the optically usable region NB. Hence, the solution according to the invention prevents stress from being induced into the optically usable region NB and, as a consequence, prevents the optical properties of the optical assembly from being negatively changed.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An optical assembly comprising:
an optical element with an optical axis;
a frame configured to hold the optical element at a plurality of positions; and
a plurality of slots that are respectively arranged between the plurality of positions and the optical axis in the optical element.

2. The optical assembly according to claim 1, wherein the optical element comprises a plurality of bearing elements, and wherein the plurality of positions are formed by the plurality of bearing elements.

3. The optical assembly according to claim 1, wherein the optical element has a rotationally symmetric embodiment, and wherein the plurality of slots are circular segments in the optical element.

4. The optical assembly according to claim 1, wherein the plurality of slots each have a first end and a second end, and wherein the plurality of positions are arranged between the first end and the second end in each case or are arranged midway between the first end and the second end in each case.

5. The optical assembly according to claim 1, wherein the optical element comprises exactly three bearing elements that are respectively arranged offset from one another by 120°.

6. The optical assembly according to claim 1, wherein the optical element comprises a first surface and a second surface, and wherein the plurality of slots are in each case embodied continuously from the first surface to the second surface.

7. The optical assembly according to claim 1, wherein the bearing elements are monolithically formed on the optical element or cemented to the optical element.
